(19) United States
(12) Patent Application Publication
(10) Pub. No.: US 2024/0387094 A1
(43) Pub. Date: Nov. 21, 2024

(54) MATERIAL FOR TRANSFORMER TANK AND TRANSFORMER TANK

(71) Applicant: Virginia Transformer Corporation, Roanoke, VA (US)

(72) Inventors: Prabhat K. JAIN, Roanoke, VA (US); Amitabh SARKAR, Pocatello, ID (US)

(73) Assignee: Virginia Transformer Corporation, Roanoke, VA (US)

(21) Appl. No.: 18/665,705

(22) Filed: May 16, 2024

Related U.S. Application Data
(60) Provisional application No. 63/502,784, filed on May 17, 2023.

(51) Int. Cl. H01F 27/02

(52) U.S. Cl. CPC H01F 27/025

(57) ABSTRACT

A transformer tank is made of a fibre reinforced polymer (FRP) and therefore there may be no stray current circulation on the walls of the tank, and the FRP may not rust or corrode over time. A transformer tank assembly includes: a front wall; a right wall adjacent the front wall; a left wall adjacent the front wall and opposite the right wall; a back wall adjacent the right wall and left wall and opposite the front wall; and a base connected to each said wall. Each wall is connected to its adjacent neighbors thereby defining together defining a tank. A top cover may be included, for example detachably coupled to a top of the tank.

### CROSS-REFERENCE TO RELATED APPLICATION

This application claims the benefit of priority of U.S. provisional patent application No. 63/502,784 titled “Material for Transformer Tank and Transformer Tank,” filed on May 17, 2023, which is incorporated herein in its entirety by this reference.

### TECHNICAL FIELD

The present disclosure relates to electrical utility equipment, and particularly, to the present disclosure relates particularly to a fibre reinforced polymer (FRP).

### BACKGROUND

Transformer tanks are often used to hold, protect, and cool the windings and cores in various electrical distribution transformers. Currently most transformer tanks are made of mild steel or related materials. Due to the use of mild steel or related materials many transformer tanks suffer from a number of issues, for example tray flux in the steel can contribute to overheating, the flanged joints commonly used to assemble the steal may be prone to leaks, and the live parts may run into dielectric clearance issues. In addition, steel or other metals rust over time, causing a deterioration of the efficacy of the tank.

### SUMMARY

In one or more exemplary embodiments, a transformer tank may be described. In an exemplary embodiment the transformer tank may be made of a fibre reinforced polymer (FRP). It may be understood that the FRP is non-metallic, and therefore there may be no stray current circulation on the walls of the tank, and the FRP may not rust or corrode over time.

In at least one embodiment, a transformer tank assembly includes: a front wall; a right wall adjacent the front wall; a left wall adjacent the front wall and opposite the right wall; a back wall adjacent the right wall and left wall and opposite the front wall; and a base connected to each said wall. Each wall is connected to its adjacent neighbors thereby defining together defining a tank. The tank is formed of fibre reinforced polymer (FRP) thereby having no stray electrical current circulation in said walls and base.

The fibre reinforced polymer (FRP) may contain at least one of resin, gelcoat, electrical grade epoxy, and glass fibre.

The FRP may include at least one of E-Glass 300/450GSM, and roving Mat 900/1200GSM, and has a compound density of 2000 kg/m3.

One or more of said walls may include a plurality of ridges that rigidify the tank.

One or more accessory box may be included, each said accessory box mounted on a respective one of said walls.

At least one lifting lug may be attached to at least one of said walls.

The lifting lug may be reinforced with metal.

Metal framing may be included to support lifting the transformer tank assembly.

At least a portion of the tank is molded around at least a portion of the metal framing.

In some examples, one or more metallic insert is provided, embedded into one of said walls.

One or more metallic insert may include prongs extending into one of the walls to provide support.

At least one accessory may be fitted onto at least one of the one or more metallic insert.

The at least one accessory may be a high-voltage (HV) bushing or a low-voltage (LV) bushing.

Multiple metallic inserts may be embedded into one of said walls and electrically connected together.

One or more feed-through terminals may be embedded into one of the walls.

A low volt (LV) bushing may be integrated into one of the walls, and a conducting metal plate within the interior of the one of said walls may welded to the LV bushing.

A high-voltage (HV) bushing may be integrated into one of the walls, the HV bushing including a connector portion extending past the one of said walls to secure the HV bushing in place.

The connector portion may be reinforced with FRP.

A top cover may be included, for example detachably coupled to a top of the tank.

### BRIEF DESCRIPTION OF THE DRAWINGS

The previous summary and the following detailed descriptions are to be read in view of the drawings, which illustrate some, but not all, embodiments and features as briefly described below. The summary and detailed descriptions, however, are not limited to only those embodiments and features explicitly illustrated.

FIG. 1 is an isometric perspective view of an exemplary transformer tank.

FIG. 2 is a front view of an exemplary transformer tank.

FIG. 3 is an isometric perspective view of an exemplary transformer tank with corrugated fins.

FIG. 4 is a back view of an exemplary transformer tank.

FIG. 5 is an exemplary lifting lug.

FIG. 6 is an exemplary metal framing to support lifting.

FIG. 7 is an exemplary metal framing installed on an exemplary transformer tank.

FIG. 8 is an exemplary view of an installed assembly part.

FIG. 9 is an exemplary internal view of an HV bushing.

FIG. 10 is an exemplary back view of an installed assembly part.

### DETAILED DESCRIPTIONS

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention,” “embodiments” or “invention” do not require that all embodiments of the invention include the discussed feature, advantage or mode of operation.

In one or more exemplary embodiments a transformer tank may be described. In an exemplary embodiment the transformer tank may be made of a fibre reinforced polymer (FRP). It may be understood that the FRP is non-metallic, and therefore there may be no stray current circulation on the walls of the tank, and the FRP may not rust or corrode over time.

FRP may be, for example, a fibre reinforced polymer that contains resin and/or gelcoat, such as electrical grade epoxy & glass fibre. An exemplary FRP may be made of E-Glass 300/450GSM, Roving Mat 900/1200GSM, and may have a compound density of 2000 kg/m3. It may be understood that the exemplary FRP may have high tensile strength, and that the resin & glass content may be adjusted to optimize the FRP for a particular use case or design.

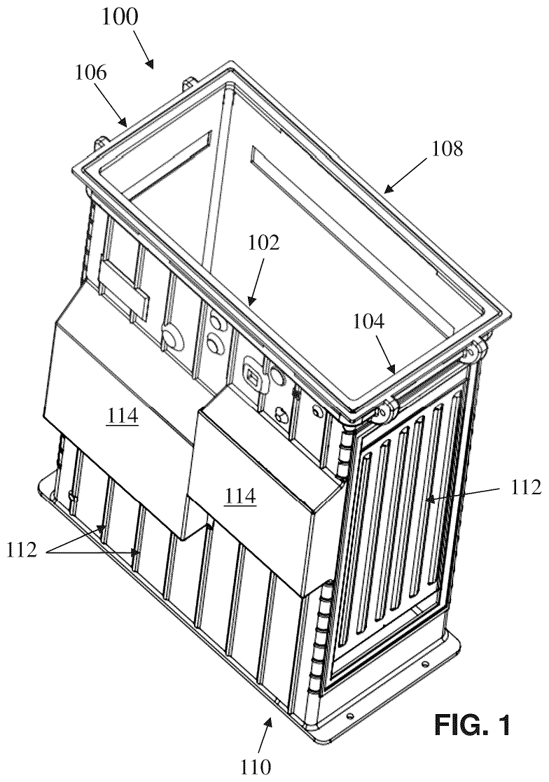

Referring now to FIG. 1, an isometric perspective view of an exemplary transformer tank 100 may be shown. The transformer tank 100 may have a front wall 102, a right wall 104 adjacent the front wall 102, a left wall 106 adjacent the front wall 102 and opposite the right wall 104, and a back wall 108 adjacent the right wall 104 and left wall 106 and opposite the front wall 102. Each wall 102-108 is connected to its adjacent neighbors and to a base 110, thereby defining together a container, herein termed also a tank.

One or more of the walls may have a plurality of ridges 112 that rigidify the walls of the tank where there are present and increase outer surface area to promote heat exchange with the surroundings of tank. The front wall 102 may further have one or more accessory boxes 114, which may, for example, cover various fittings or other components. In other embodiments the one or more accessory boxes may additionally or instead be on one or more of the right wall 104, the left wall 106, and/or the back wall 108.

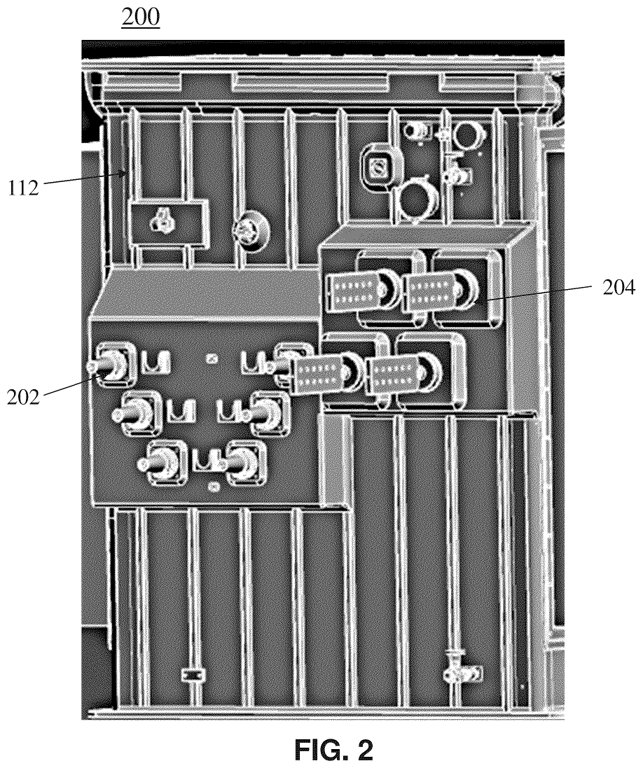

Referring now to FIG. 2, a front view of an exemplary transformer tank with accessory fittings 200 may be shown. In an exemplary embodiment one or more metallic inserts 202 may be embedded on one or more walls of the tank. One or more accessories 204 may be fitted onto the plurality of metallic inserts 202, thereby integrating the one or more accessories 204 with the tank. In some embodiments the accessories 204 may be, for example, high-voltage (HV) or low-voltage (LV) bushings. The metallic inserts 202 may be shorted together and/or connected to a grounding pad, which may be, for example, provided on the tank wall. In some embodiments one or more feed through terminals may be embedded in the tank wall, which may enable the tank to maintain required creepage distances.

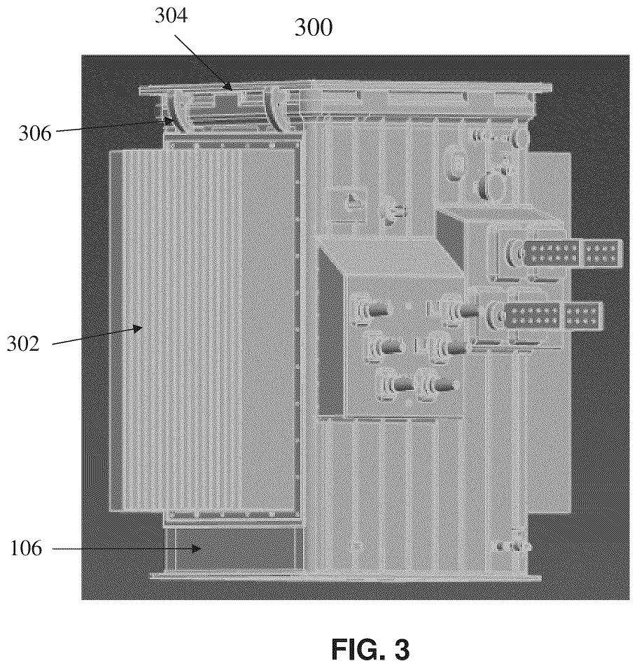

Referring now to FIG. 3, an isometric view of an exemplary transformer tank with corrugated fins 300 may be shown. One or more of the tank walls may have one or more embedded corrugated fins 302, which may dissipate heat generated by electrical losses of the transformer. The corrugated fins 302 may be made of, for example, CRCA sheet. The tank may have a top cover 304, which may be detachable. The top cover may be fixed or detachably coupled to a top of the tank defined by tops of the wall, via, for example, spring laded clamps. The top cover may further have one or more lifting lugs 306.

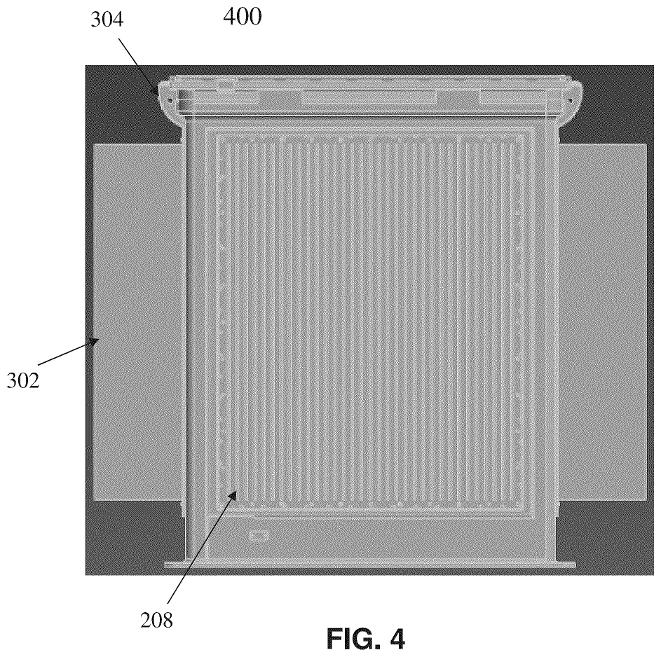

Referring now to FIG. 4, a back view of an exemplary transformer tank 400 may be shown.

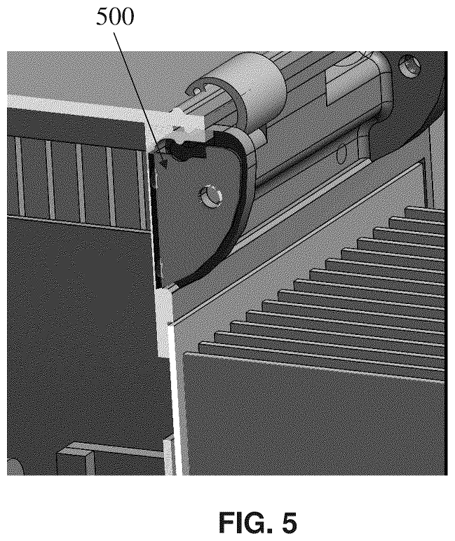

Referring now to FIG. 5, exemplary specialized lifting lugs 500 may be shown. The lifting lugs 500 may be used to distribute load to the side and bottom of the tank. The lifting lugs 500 may be reinforced with interior metallic framing. The lifting lugs may be further reinforced with, for example, steel.

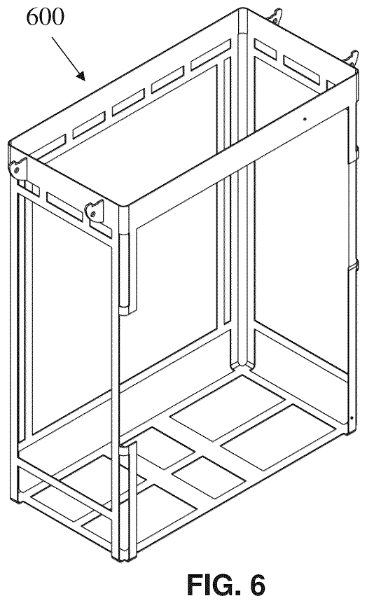

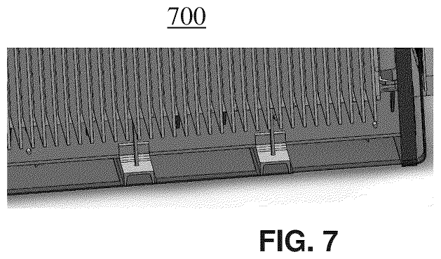

Referring now to FIG. 6-7, an exemplary metal framing 600 to support lifting may be shown, and an exemplary installed metal framing 700 may be shown. It may be understood that the metal framing may provide support for the exemplary transformer tank. In some embodiments molded sections of FRP for the exemplary transformer tank may be molded around the metal framing, or may be otherwise adhered to the metal framing.

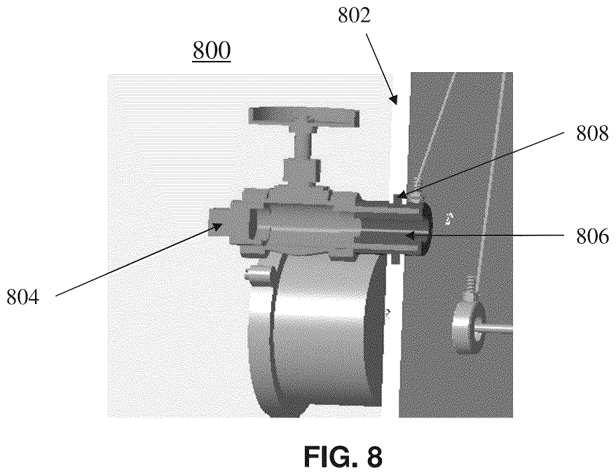

Referring now to FIG. 8, an exemplary view of an installed assembly part 800 may be shown. The assembly part may be installed into the shell of the transformer 802 defined by the walls. The portion of the assembly part 804 inserted into the shell 802 may be sandwiched in between a metal insert 806, which may provide stability for the assembly part. In some embodiments the metal inserts 806 may have one or more prongs 808 that extend into the transformer shell 802 in order to provide additional support for the assembly part 804.

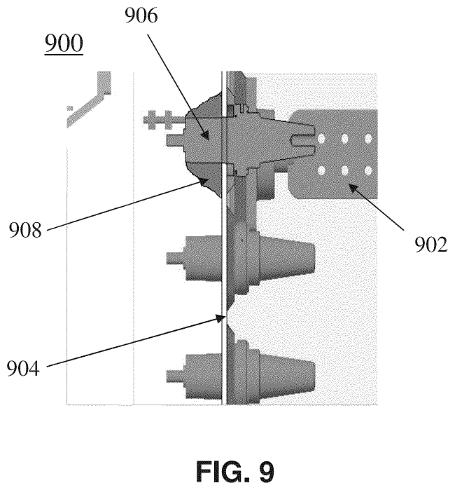

Referring now to FIG. 9, an exemplary view of a HV bushing 900 may be shown. An HV bushing 902 may be integrated into the transformer wall 904. The HV bushing 902 may have a connector 906 portion that extends past the transformer wall 904 to secure the HV bushing 902 in place. The connector 906 may then be further reinforced, for example with FRP.

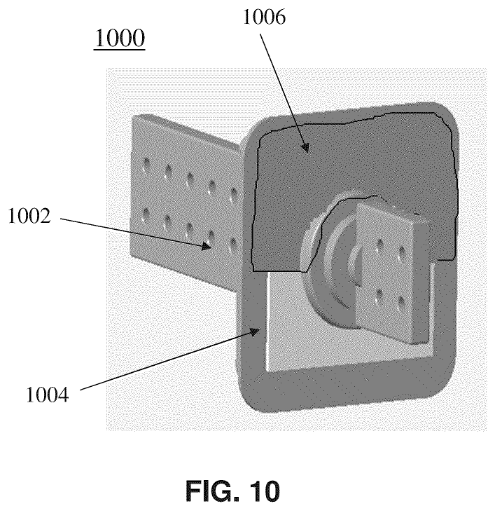

Referring now to FIG. 10, an exemplary view of a LV bushing 1000 may be shown. A LV bushing 1002 may be integrated into the transformer wall, and may have an aluminum plate 1004 welded to the LV bushing interior of the transformer wall in order to hold the LV bushing 1002 in place. In some embodiments the aluminum plate 1004 may be further reinforced with an FRP coating 1006. In an exemplary embodiment, the transformer tank may be formed by filling a mold of the transformer tank with an FRP. It may be understood that by molding the transformer tank body there welding or plate joining may not be required, and leakage may be prevented. In some embodiments, during the molding process color shading may be added to the FRP material, which may allow for coloring of the transformer tank without needing an additional painting step. It may be understood that in the embodiment where the tank is formed from FRP the weight may be lower than traditional steel tanks, for example ¼ the weight of an equivalent sized traditional steel tank.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

1. A transformer tank assembly comprising:
a front wall;
a right wall adjacent the front wall;
a left wall adjacent the front wall and opposite the right wall;
a back wall adjacent the right wall and left wall and opposite the front wall; and
a base connected to each said wall; and
wherein each wall is connected to its adjacent neighbors thereby defining together defining a tank; and
wherein the tank is formed of fibre reinforced polymer (FRP) thereby having no stray electrical current circulation in said walls and base.

2. The transformer tank assembly of claim 1, wherein the fibre reinforced polymer (FRP) contains at least one of resin, gelcoat, electrical grade epoxy, and glass fibre.

3. The transformer tank assembly of claim 2, wherein the FRP comprises at least one of E-Glass 300/450GSM, and roving Mat 900/1200GSM, and has a compound density of 2000 kg/m³.

4. The transformer tank assembly of claim 1, wherein one or more of said walls comprises a plurality of ridges that rigidify the tank.

5. The transformer tank assembly of claim 1, further comprising one or more accessory box, each said accessory box mounted on a respective one of said walls.

6. The transformer tank assembly of claim 1, further comprising at least one lifting lug attached to at least one of said walls.

7. The transformer tank assembly of claim 6, wherein the lifting lug is reinforced with metal.

8. The transformer tank assembly of claim 1, further comprising metal framing to support lifting the transformer tank assembly.

9. The transformer tank assembly of claim 8, wherein at least a portion of the tank is molded around at least a portion of the metal framing.

10. The transformer tank assembly of claim 1, further comprising one or more metallic insert each embedded into one of said walls.

11. The transformer tank assembly of claim 1, wherein at least one said metallic insert comprises prongs extending into one of said walls to provide support.

12. The transformer tank assembly of claim 1, further comprising at least one accessory fitted onto at least one of the one or more metallic inserts.

13. The transformer tank assembly of claim 12, wherein the at least one accessory comprises a high-voltage (HV) bushing or a low-voltage (LV) bushing.

14. The transformer tank assembly of claim 1, further comprising multiple metallic inserts embedded into one of said walls and electrically connected together.

15. The transformer tank assembly of claim 1, further comprising one or more feed-through terminal each embedded into one of said walls.

16. The transformer tank assembly of claim 1, further comprising:
a low volt (LV) bushing integrated into one of said walls; and
a conducting metal plate within the interior of the one of said walls and welded to the LV bushing.

17. The transformer tank assembly of claim 1, further comprising:
a high-voltage (HV) bushing integrated into one of said walls, the HV bushing comprising a connector portion extending past the one of said walls to secure the HV bushing in place.

18. The transformer tank assembly of claim 17, wherein the connector portion is reinforced with FRP.

19. The transformer tank assembly of claim 1, further comprising a top cover.

20. The transformer tank assembly of claim 19, wherein the top cover is detachably coupled to a top of the tank.
